(19) United States
(12) Patent Application Publication
(10) Pub. No.: US 2008/0140841 A1
(43) Pub. Date: Jun. 12, 2008

(54) Method and apparatus for detecting the IP address of a computer, and location information associated therewith

(76) Inventor: Robert Ott, Eschlikon (CH)

Correspondence Address: PAUL, HASTINGS, JANOFSKY & WALKER LLP, 875 15th Street, NW, Washington, DC, 20005, US

(21) Appl. No.: 11/652,474

(22) Filed: Jan. 12, 2007

(30) Foreign Application Priority Data
Dec. 8, 2006 (EP) 06025451.3

(51) Int. Cl. G06F 15/173

(52) U.S. Cl. 709/226

(57) ABSTRACT

The invention relates to a method for operating a computer network, a computer network, and an apparatus for use in the network. According to an aspect of the invention, a method for operating a computer network comprises: from a first device of the network, requesting access to a second device of the network; redirecting the request to a third device of the network; detecting location information associated with the first device by use of the third device; and redirecting the request to the second device.

This application claims the benefit of European Patent Application No. 06025451.3, filed Dec. 8, 2006, which is herein incorporated by reference in its entirety.

### BACKGROUND

1. Field of the Invention

The invention relates to a method for operating a computer network, a computer network, and an apparatus for use in the network. In particular, the invention relates to a method and an apparatus for detecting an address, in particular, an IP address of a computer in a computer network, and/or country/location information associated with the computer and/or the IP address.

2. Background of the Invention

The Internet is a worldwide, publicly accessible network of interconnected computers/computer networks that transmit data by packet switching using the Transmission Control Protocol (TCP), and the Internet Protocol (IP).

The Internet can be seen as a “network of networks” that consists of millions of smaller domestic, academic, business, and government networks, which together carry various information and services, such as electronic mail, online chat, file transfer, and interlinked Web pages and other documents of the World Wide Web.

The Internet and the World Wide Web are not synonymous: the Internet is a collection of interconnected computer networks/computers, linked by copper wires, fiber-optic cables, wireless connections, etc.; the World Wide Web is a collection of interconnected documents and other resources, linked by hyperlinks and URLs (Uniform Resource Locators). The World Wide Web is accessible via the Internet.

An Intranet can be understood as a “private version of the Internet”, or as a version of the Internet confined to an organization, e.g., a bank, an insurance company, etc.

An Intranet is a private computer network that uses Internet protocols, such as TCP/IP, network connectivity, and possibly the public telecommunication system to securely share part of an organization's information with its employees.

Some web based applications, stored in a respective web application server, require information regarding the country/location from where a user—e.g. via a web client—accesses a respective application.

When the application is deployed within an Intranet, for this purpose, a table or list or file might be used, wherein for each web client IP address the associated country/location information is stored (“country/location lookup table”).

If the user accesses the web application server directly—without any intermediate HTTP proxy server—via a respective web client, the IP address of the web client (and hence, by use of the lookup table, also the respective country/location information) can easily be determined: In this case, the client's IP address corresponds to the “remote-address” of the respective TCP/IP connection.

If, however, the user accesses the web application via one or several intermediate HTTP proxy servers, the IP address of the client does not correspond to the “remote-address” of the respective TCP/IP connection. However, the HTTP proxy servers can be configured to extend the standard HTTP header “X-forwarded-For” with the client's IP address. More precisely, the HTTP proxy servers may be configured such that the respective “X-forwarded-For” HTTP header is added/modified such that the HTTP header received at the web application server does not only comprise the IP address of the HTTP proxy server (directly) connected with the web application server, but also the IP addresses of all other HTTP proxy servers between the web application server, and the client, as well as the client's IP address.

Hence, if an Intranet only comprises HTTP proxy servers configured as said above, again, by use of the above “country/location lookup table”, information regarding the country/location from where a user accesses a respective web application can be detected (by first detecting the client's IP address—as explained above—and then using the “country/location lookup table” to determine which country/location is associated with the respective IP address).

To enhance the security of Internet/Intranet connections, TLS (Transport Layer Security) and its predecessor, SSL (Secure Sockets Layer) protocols might be used. TLS/SSL are cryptographic protocols that allow client/server applications to communicate in a way to prevent eavesdropping, tampering, message forgery, etc.

However, if an HTTP connection is established using TLS/SSL, respective HTTP proxy servers between a client and a web application server cannot add or modify HTTP headers, because the content exchanged between the client and the server—including HTTP headers—is encrypted, and therefore, immutable by the HTTP proxy servers.

Hence, the HTTP proxy servers cannot extend the HTTP header “X-forwarded-For” with the client's IP address, as explained above. Therefore, the web application server cannot detect the client's IP address, and thus cannot determine the country/location associated with the respective IP address by use of the “country/location lookup table”.

### BRIEF SUMMARY OF THE INVENTION

According to an embodiment of the invention, there is provided a method for operating a computer network, comprising the steps:
(a) from a first device of the network, requesting access to a second device of the network;
(b) redirecting the request to a third device of the network;
(c) detecting location information associated with the first device by use of the third device;
(d) redirecting the request to the second device.
   According to a further embodiment of the invention, a computer network comprises:

at least a first, second, and third device, wherein the second device is adapted to redirect an access request of the first device to the third device for detecting location information associated with the first device.

Advantageously, the access request of the first device is a secure Internet/Intranet connection request, and the redirected request is a normal, un-secure Internet/Intranet connection request.

Further, advantageously, the third device detects the location information by detecting the IP address of the first device.

Advantageously, the third device transmits the detected location information by again redirecting the access request. Particularly advantageously, the detected location information is transmitted by use of URL encoding.

Further features and advantages of the present invention will become apparent from the following detailed description of the invention made with reference to the accompanying drawings.

### BRIEF DESCRIPTION OF THE DRAWINGS

The accompanying drawings are included to provide a further understanding of the present invention and are incorporated in and constitute a part of this specification. The drawings illustrate embodiments of the present invention and together with the description serve to explain the principles of the invention. Other embodiments of the present invention and many of the intended advantages of the present invention will be readily appreciated as they become better understood by reference to the following detailed description.

FIG. 1 schematically illustrates a section of an Intranet computer system according to an embodiment of the invention.

FIG. 2 schematically illustrates an example of a country/location lookup table that might be used in the Intranet computer system shown in FIG. 1.

FIG. 3 schematically illustrates method steps used according to an embodiment of the invention to detect the IP address of a client, and the country/location associated with the respective IP address.

FIG. 4 schematically illustrates the interaction of components of the Intranet computer system shown in FIG. 1 to perform the method steps according to the embodiment of the invention.

### DETAILED DESCRIPTION OF THE INVENTION

In the following Detailed Description, reference is made to the accompanying drawings, which form a part hereof, and in which is shown by way of illustration specific embodiments in which the invention may be practiced. It is to be understood that other embodiments may be utilized and structural or other changes may be made without departing from the scope of the present invention. The following detailed description, therefore, is not to be taken in a limiting sense, and the scope of the present invention is defined by the appended claims.

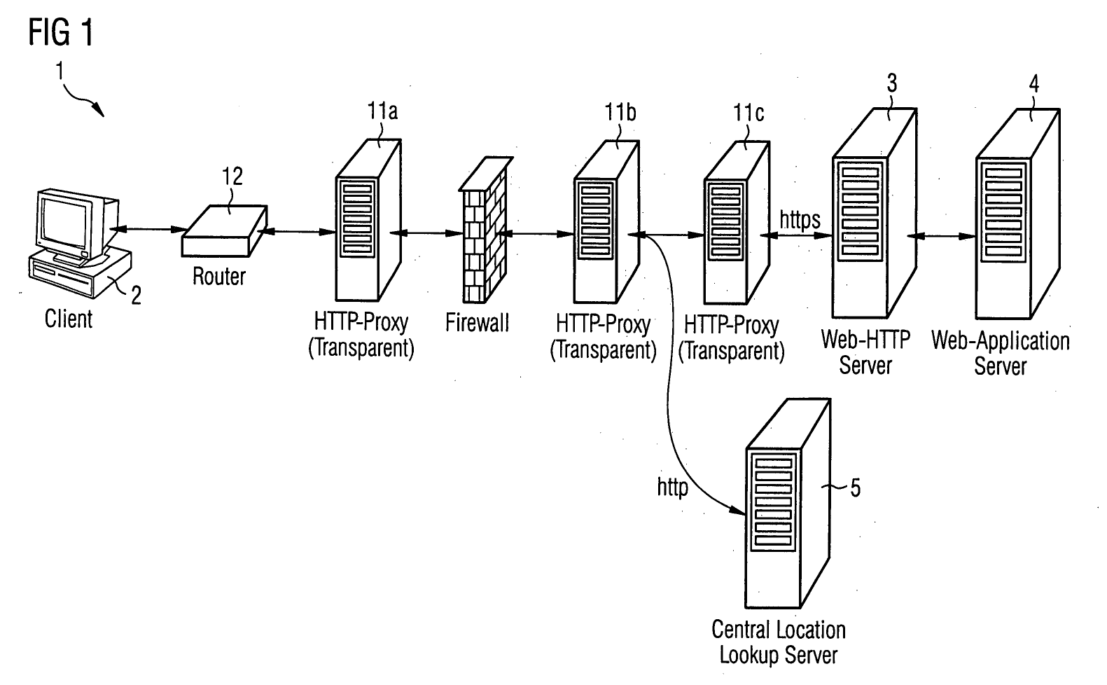

FIG. 1 schematically illustrates a section of an Intranet computer system 1 according to an embodiment of the invention. The system 1 comprises a plurality of computers (or, more generally speaking, electronic devices)—e.g. respective PCs (personal computers) 2, work station computers, server computers 3, 4, 5, etc.

Between the computers 2, 3, 4, 5 data might be exchanged using the Transmission Control Protocol (TCP), and the Internet Protocol (IP).

The Intranet computer system 1 shown in FIG. 1 can be understood as a “private version of the Internet”, or as a version of the Internet confined to an organization, e.g., a bank, an insurance company, etc.

The Intranet computer system 1—here: of a bank—might be used to securely share part of the respective organization's information with its employees.

To the Intranet computer system 1, hundreds or thousands of computers 2, 3, 4, 5 might be connected.

The computers 2, 3, 4, 5 might be located at a plurality of different locations/countries.

Some web based applications, stored in a respective web application server (e.g., the above server computer 4), require information regarding the country/location from where a user accesses a respective application.

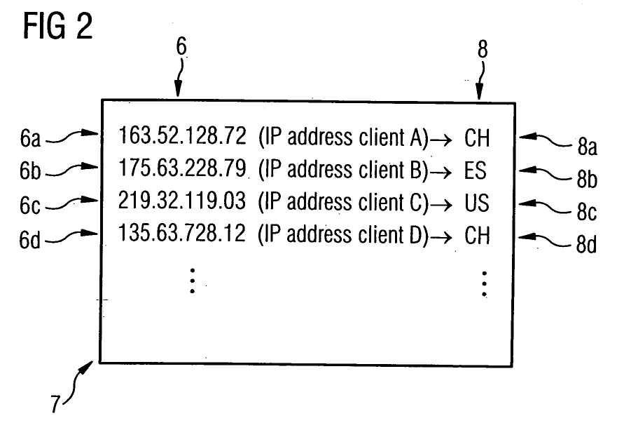

For this purpose, a table or list or file might be used, wherein for IP addresses of respective computers 2, 3, 4, 5, the associated country/location information is stored (“country/location lookup table” 7, see FIG. 2).

As is shown in FIG. 2, each IP address e.g. might comprise four groups of numbers, separated by respective dots.

As is further shown in FIG. 2, the country/location lookup table 7 might comprise two—or more—groups of data fields: A first group of data fields 6a, 6b, 6c, 6d for storing respective IP addresses of computers 2, 3, 4, 5 comprised in the above Intranet computer system 1 (here: of clients A, B, C, D of the computer system, etc.), and a second group of data fields 8a, 8b, 8c, 8d for storing information regarding country/location information—e.g., respective country codes—associated with the respective IP addresses (and hence, the respective clients A, B, C, D).

For instance, according to the specific example shown in FIG. 2, the country/location lookup table 7 indicates that a first client A with the IP address “163.52.128.72” is located in Switzerland (here: country code “CH”), that a second client B with the IP address “175.63.228.79” is located in Spain (here: country code “ES”), that a third client C is located in the USA (here: country code “US”), and that a fourth client D is located in Switzerland (here: country code “CH”).

As country code, any suitable code might be used, in particular, for example, the 2-digit country code according to ISO-3166, etc.

Instead of the above country information (and/or in addition thereto), respective (further) location information might be stored in the table 7, e.g. information regarding the canton/province/state/city where a respective client is located, etc., etc.

According to a first embodiment of the invention, for each and every computer 2, 3, 4 of the Intranet computer system 1, the respective IP address, and the associated country/location information is stored in the table 7.

In a further—alternative—embodiment, for the computers 2 of a first group of the computers of the Intranet computer system 1, the respective IP addresses, and the associated country/location information is stored in the table 7. However, for the computers of a second group, the respective IP addresses are not stored in the table 7 (or e.g. the IP addresses, but not the associated country/location information, etc.).

If a user accesses the web application stored in the server computer 4 directly—without any intermediate HTTP proxy server—via a respective web client (here: the client computer 2), the IP address of the web client can easily be determined: In this case, the client's IP address corresponds to the “remote-address” of the respective TCP/IP connection.

After having detected the client's IP address, the above “country/location lookup table” 7 shown in FIG. 2 is used to determine which country/location is associated with the respective IP address.

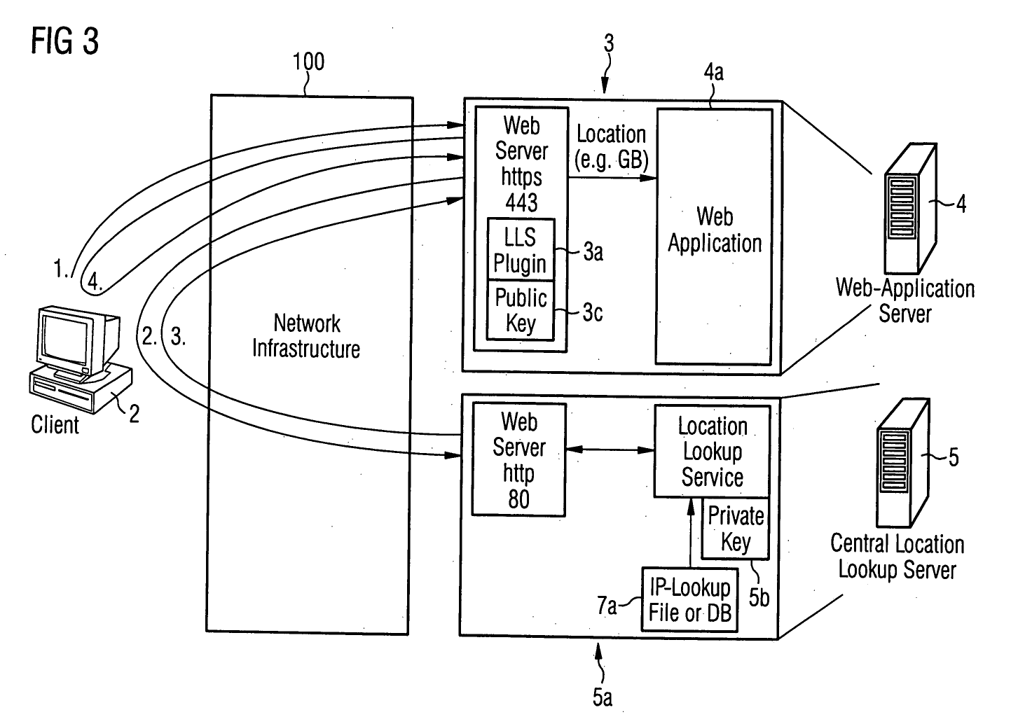

As is further shown in FIG. 1, the Intranet computer system 1 also comprises several HTTP proxy servers 11a, 11b, 11c, router computers 12, firewalls 13, etc. (e.g., tens or hundreds or thousands of HTTP proxy servers 11a, 11b, 11c, tens or hundreds or thousands of router computers 12, firewalls 13, etc., i.e., respective “network infrastructure” 100 (see also FIG. 3)).

If—as is shown in FIG. 1—the user accesses the web application stored on the server computer 4 via one or several of the above HTTP proxy servers (here: the HTTP proxy servers 11a, 11b, 11c), the IP address of the client does not correspond to the “remote-address” of the respective TCP/IP connection.

However, all the (tens or hundreds or thousands) HTTP proxy servers 11a, 11b, 11c in the Intranet computer system 1 shown in FIG. 1 are configured to extend the “X-forwarded-For” HTTP header with the client's IP address.

More precisely, the HTTP proxy servers 11a, 11b, 11c are configured such that the respective “X-forwarded-For” HTTP header is added/modified such that the HTTP header received at the web application server does not only comprise the

IP address of the HTTP proxy server which in the chain of HTTP proxy servers between the client and the web application is closest to the web application server (here: the HTTP proxy server 11c), but also the IP addresses of all other HTTP proxy servers between the web application server, and the client (here: the HTTP proxy servers 11a, 11b), as well as the client's IP address (here: the IP address of the client computer 2).

Again, after having detected the client's IP address (here: the IP address of the client computer 2), the above “country/location lookup table” 7 shown in FIG. 2 is used to determine which country/location is associated with the respective IP address (i.e., the detected IP address of the client computer 2).

If a user via a respective web client (here: the client computer 2) accesses the web application stored in the server computer 4 by use of a “secure” Internet/Intranet connection, in particular, a TLS (Transport Layer Security)/SSL (Secure Sockets Layer) connection, according to an embodiment of the invention, the following procedure might be applied to detect the client's IP address, and the country/location associated with the respective IP address:

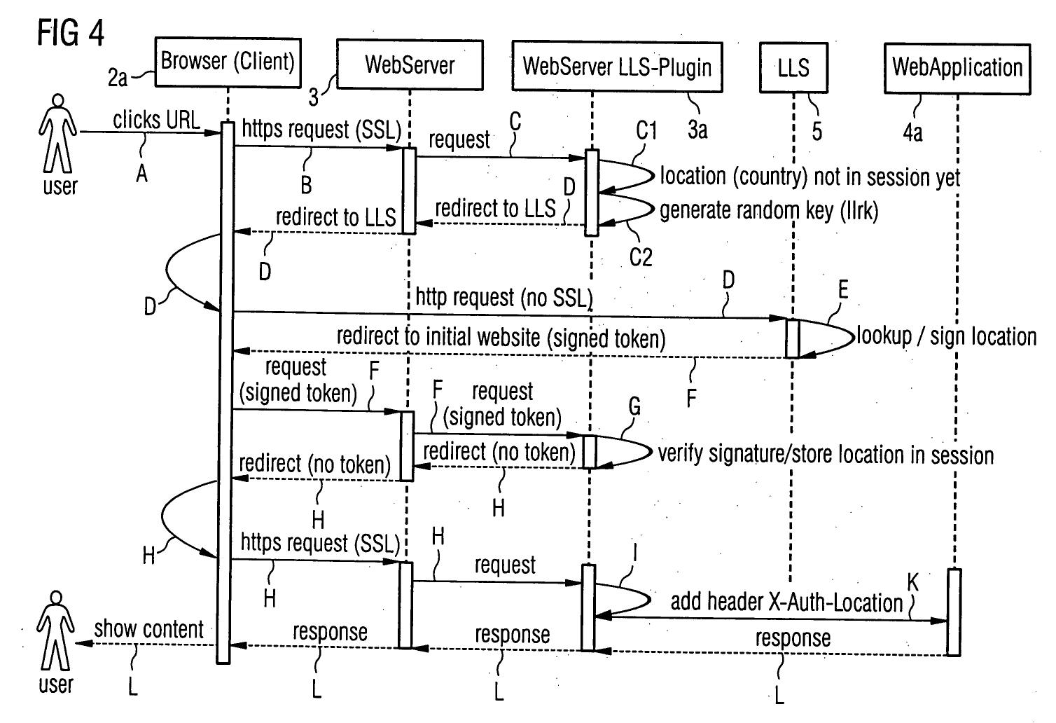

First, the user, by use of the web browser 2a running on the client computer 2, requests access to the web application 4a stored in the server computer 4. For this purpose, the respective web address/URL (Uniform Resource Locator), e.g.
“https://myapp.mycompany.com/app-path/”
   is entered into the web browser, and is “clicked” by the user (see also FIG. 4, arrow “A”). Thereby, “https” signifies that the connection is to be a “secure” Internet/Intranet connection (whilst “http” would have signified that the connection is to be a normal, “un-secure” connection). Further, “myapp.mycompany.com” is the web address/URL of the server computer 4 on which the web application 4a is stored, and “app-path/” the name of the path where the web application 4a is stored on the server computer 4.

As is shown in FIGS. 3 and 4, the https—request of the user is e.g. intercepted by a web server 3 located between the client computer 2, and the server computer 4 on which the web application 4a is stored, or a specific program 3 stored on the server computer 4 (see also FIG. 4, arrow “B”, FIG. 3, arrow “1.”). Then, a request to a LLS-Plugin 3a, e.g., an apache module, stored on the web server/server computer is issued (see FIG. 4, arrow “C”).

The LLS-Plugin 3a—as will be described in further detail below—checks whether or not the respective country/location information for the client computer 2 has already been determined (see FIG. 4, arrow “C1”). If not, the LLS-Plugin 3a for the respective request of the web browser 2a generates a random key (here: a parameter llrk) (see FIG. 4, arrow “C2”), and stores the generated random key for later validation in the HTTP session context of the client computer 2.

Further, the LLS-Plugin 3a redirects the request of the web browser 2a to a central location lookup server 5 (see FIG. 4, arrows “D”, as well as FIG. 3, arrow “2.”). Thereby, the originally entered web address/URL of the server computer 4 on which the web application 4a is stored, and the name of the path where the web application 4a is stored on the server computer 4 are provided (here: by use of a parameter llurl), as well as the random key generated by the LLS-Plugin 3a (here: the above parameter llrk). In particular, the above parameters Ilurl and llrk are provided as URL encoded request parameters of the redirected request of the web browser 2a to the central location lookup server 5.

For instance, the request of the web browser 2a may be redirected by the LLS-Plugin 3a using a redirection web address

“http://lls.mycompany.com/lls/lookup?llurl=https%3A%2F%2Fmyapp.-
mycompany.com%2Fapp-path%2F&llrk=wahczcrnssrrmrlxlpuv”.

Thereby, “http” signifies that the connection is to be a normal, “non-secure” Internet/Intranet connection (whilst “https” would have signified that the connection is to be a “secure” TLS-/SSL-connection). Further, “lls.mycompany.com” is the web address/URL of the central location lookup server 5 to which the request is rediected, and “lls/” the name of the path where a respective location lookup service program 5a is stored on the central location lookup server 5. Further, as already mentioned, the URL encoded request parameter llurl (here: “myapp.mycompany.com”, and “app-path/”) signifies the web address/URL of the originally requested server computer 4, and the name of the path where the originally requested web application 4a is stored on the server computer 4. In addition, as also already mentioned, the URL encoded request parameter llrk (here: “wahczcrnssrrmrlxlpuv”) signifies the above random key generated by the LLS-Plugin 3a.

As the (redirected) connection between the client computer 2/web browser 2a, and the central location lookup server 5 is a normal, “non-secure” Internet/Intranet connection (in particular, not a TLS-/SSL-connection), the location lookup service program 5a stored on the central location lookup server 5 may then correspondingly similar as explained above detect the IP address of the web client/client computer 2:

In particular, if the web client/client computer 2 via the above redirected connection accesses the central location lookup server 5 directly—without any intermediate HTTP proxy server—, the IP address of the web client/client computer corresponds to the “remote-address” of the respective—redirected—TCP/IP connection.

If—as is shown in FIG. 1—the web client/client computer 2 via the above redirected connection accesses the central location lookup server 5 via one or several of the above HTTP proxy servers (here: the HTTP proxy servers 11a, 11b, 11c), the IP address of the web client/client computer 2 does not correspond to the “remote-address” of the respective—redirected—TCP/IP connection.

However, as explained above, all the (tens or hundreds or thousands) HTTP proxy servers 11a, 11b, 11c in the Intranet computer system 1 shown in FIG. 1 are configured to extend the “X-forwarded-For” HTTP header with the client's IP address.

More precisely, as explained above, the HTTP proxy servers 11a, 11b, 11c add/modify the respective “X-forwarded-For” HTTP header such that the HTTP header received at the central location lookup server 5 not only comprises the IP address of the HTTP proxy server which in the chain of HTTP proxy servers between the client computer 2 and the central location lookup server 5 is closest to the central location lookup server 5 (here: the HTTP proxy server 11c), but also the IP addresses of all other HTTP proxy servers between the central location lookup server 5, and the client computer 2 (here: the HTTP proxy servers 11a, 11b), as well as the IP address of the client computer 2.

In particular, the IP address of the client computer 2 corresponds to the last entry of the “X-forwarded-For” HTTP header received at the central location lookup server 5.

After having detected the client's IP address (here: the IP address of the client computer 2), the above “country/location lookup table” 7 shown in FIG. 2 is used by the location lookup service program 5a stored on the central location lookup server 5 to determine which country/location is associated with the respective IP address (i.e., the detected IP address of the client computer 2) (see FIG. 4, arrow “E”).

The “country/location lookup table” 7—as is shown in FIG. 3—e.g. might be stored in a respective IP-Lookup File or Databank (DB) 7a of the central location lookup server 5

For instance, if it was detected by the location lookup service program 5a stored on the central location lookup server 5 that the IP address of the client computer 2 is “163.52.128.72”, according to the table 7 shown in FIG. 2, the respective client computer 2 is located in Switzerland (country code: “CH”).

If the detected IP address is not contained in the table 7 shown in FIG. 2, or if the IP address is stored in the table 7, but without an associated country code, or if the associated country code e.g. is “XB”, signifying that the country/location is unknown, it is detected by the location lookup service program 5a that no country/location is associated with the respective IP address.

After detecting the country/location, a token (string sequence) is created by the location lookup service program 5a stored on the central location lookup server 5 comprising the following information:
<serial-id><timestamp G MT><valid seconds><version><country code><random key>

The string <serial-id> (e.g., “4131213”) is an ID to make the token unique. For instance, a first token generated by the location lookup service program 5a stored on the central location lookup server 5 may be given a first number, a second token generated by the location lookup service program 5a may be given a second, different number, a third token generated by the location lookup service program 5a may be given a third number (different from the first and second numbers), etc., e.g. by use of a counter (which e.g. is reset after a certain period of time, or e.g. is automatically reset after having reached a certain maximum number).

Further, the string <timestamp GMT> (e.g., “20050714084300GMT”) signifies the time when the respective token was generated (by giving the respective information regarding e.g. the date (year, month, day of the month), time (hours, minutes, seconds), time-zone, etc.).

In addition, the string <valid seconds> signifies for how long—e.g. from the point of time defined by the string <timestamp GMT>—the respective token is valid (e.g., several minutes or seconds, preferably, a relatively short amount of time, e.g. less than 40 or 20 seconds, etc.).

Further, the string <version> (e.g., “1”) signifies the version used for the token's syntax, such that a syntax different from the syntax explained here might also be used in the future (under a different <version> number (e.g., “2”)).

Still further, the string <country code> is the country code detected as explained above by the location lookup service program 5a stored on the central location lookup server 5 by use of the “country/location lookup table”7 (e.g., the above 2-digit country code according to ISO-3166).

Finally, the string <random key> is the above random key generated by the LLS-Plugin 3a (i.e., corresponds to the above parameter llrk (here: “wahczcrnssrrmrlxlpuv”)).

The above token (string sequence)/the above information contained in the token is then signed with a private key 5b of the location lookup service program 5a/the central location lookup server 5 (see also FIG. 3), e.g. using a sign algorithm such as SHA1 with RSA.

The token (string sequence), and the token's signature are then URL encoded, and added to the originally requested web address/URL (more exactly, the web address/URL of the server computer 4 on which the web application 4a is stored, and the path where the web application 4a is stored on the server computer 4, as defined by the above parameter llurl).

In more detail, the location lookup service program 5a redirects the request of the web browser 2a back to the above server computer 4, and the respective redirected request—again—is intercepted by the above LLS-Plugin 3a (see FIG. 4, arrows “F”, as well as FIG. 3, arrow “3.”). Thereby, the above token (string sequence) and the token's signature are provided (here: by use of a parameter llinfo) as URL encoded request parameter of the redirected request of the web browser 2a to the server computer 4.

For instance, the request of the web browser 2a may be redirected by the location lookup service program 5a to the LLS-Plugin 3a using a redirection web address
“https://myapp.mycompany.com/app-path/?llinfo=AlAdP-DKhLwX . . . ”.

Thereby, “https” signifies that the connection is to be a “secure” Internet/Intranet connection, here: a TLS-/SSL-connection. Further, “myapp.mycompany.com/app-path/” signifies the web address/URL of the originally requested server computer 4, and the name of the path where the originally requested web application 4a is stored on the server computer 4. In addition, as already mentioned, the URL encoded request parameter llinfo (here: “AlAdP-DKhLwX. . . . ”) signifies the above token, and the token's signature.

The LLS-Plugin 3a then takes the provided token, and the associated signature by performing respective URL decoding.

Then, the LLS-Plugin 3a verifies the token and the token's signature by using a public key 3c of the LLS-Plugin 3a/the web server/server computer 4, corresponding to the above private key 5b of the location lookup service program 5a/the central location lookup server 5 (see also FIG. 3).

Further, the LLS-Plugin 3a verifies that the received random key (i.e., the random key according to the string <random key> of the above token) corresponds to the above random key generated by the LLS-Plugin 3a (i.e., corresponds to the above parameter llrk (here: “wahczcrnssrrmrlxlpuv”)), and that the respective random key was previously issued by the LLS-Plugin 3a (e.g., within a predetermined amount of time, e.g., several minutes or seconds), i.e., that the random key is still valid.

In addition, the LLS-Plugin 3a checks whether or not the token is still valid by use of the strings <timestamp GMT>, and <valid seconds> of the above token (e.g., by checking whether or not a point of time defined by the point of time according to the string <timestamp GMT>, plus a period of time defined by the string <valid seconds> has already passed).

Still further, the LLS-Plugin 3a checks whether or not the token ID defined by the string <serial-id> had been used already within the period of time defined by the above string <valid seconds>.

Then, the LLS-Plugin 3a stores the token ID (i.e., the string <serial-id>), so as to be able to compare future token IDs of future requests with the stored token ID (to detect whether or not a future token ID—also defined by a respective string <serial-id>—had been used already within a period of time defined by a respective string <valid seconds>, as explained above).

Further, the country/location information as defined by the string <country code> is stored by the LLS-Plugin 3a in the HTTP session context of the client computer 2 (see FIG. 4, arrow “G”). This e.g. is done to allow the LLS-Plugin 3a—as explained above (see FIG. 4, arrow “C1”)—to check in the future whether or not the respective country/location information for the client computer 2 has already been determined.

The above storing in the HTTP session context can e.g. be realized using the SSL-Session-ID, a session cookie, or URL-rewriting.

When all of the above checks/verifications had been successful, the LLS-Plugin 3a newly redirects the request of the web browser 2a to the above server computer 4, and the respective new redirected request—again—is intercepted by the above LLS-Plugin 3a (see FIG. 4, arrows “H”, as well as FIG. 3, arrow “4.”). Contrary to the previous redirect, however, in the new redirected request, the above token/token's signature are not provided as URL encoded request parameter.

For instance, the request of the web browser 2a may be redirected by the LLS-Plugin 3a using a redirection web address
“https://myapp.mycompany.com/app-path/”
   i.e., a web address which corresponds to the web address originally entered into the web browser, i.e., originally “clicked” by the user (see also FIG. 4, arrow “A”).

Thereby, “https” signifies that the connection is to be a “secure” Internet/Intranet connection, here: a TLS-/SSL-connection. Further, “myapp.mycompany.com/app-path/” signifies the web address/URL of the originally requested server computer 4, and the name of the path where the originally requested web application 4a is stored on the server computer 4.

As as said above the country/location information as defined by the string <country code> was stored by the LLS-Plugin 3a in the HTTP session context of the client computer 2 (see FIG. 4, arrow “G”), for the new redirected request, it is detected by the LLS-Plugin 3a that the respective country/location information for the client computer 2 had already been determined (see FIG. 4, arrow “I”).

The respective country/location information is then forwarded by the LLS-Plugin as HTTP header to the originally requested web application 4a stored on the server computer 4 (see FIG. 4, arrow “K”), e.g. by adding an HTTP header “X-Auth-Location”.

The web application 4a then responds to the request of the web browser 2a (see FIG. 4, arrows “L”), and the content as provided by the web application 4a is shown on the user's web browser 2a.

The content shown at the web browser 2a, and/or the rights of the user may depend on the country/location information as detected above.

For instance, some data of the web application 4a may only be accessed (shown at the web browser 2a), and/or amended by the user if it was detected that the respective web client/client computer 2 is located at a predetermined country/location (or a predetermined set of countries/locations).

Instead or in addition, correspondingly similar, some (other) data may not be accessed (shown at the web browser 2a), and/or may not be amended by the user if it was detected that the respective web client/client computer 2 is located at a predetermined country/location (or a predetermined set of countries/locations), etc.

Still further, some (further) data may not be accessed, and/or may not be amended if the detected country code for the respective web client/client computer 2 is “XB”, signifying that the country/location is unknown.

In accordance with an embodiment of the present invention, instructions adapted to be executed by a processor to perform a method are stored on a computer-readable medium. The computer-readable medium can be a device that stores digital information. For example, a computer-readable medium includes a read-only memory (e.g., a Compact Disc-ROM, etc.) as is known in the art for storing software. The computer-readable medium can be accessed by a processor suitable for executing instructions adapted to be executed. The terms “instructions configured to be executed” and “instructions to be executed” are meant to encompass any instructions that are ready to be executed in their present form (e.g., machine code) by a processor, or require further manipulation (e.g., compilation, decryption, or provided with an access code, etc.) to be ready to be executed by a processor.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

1. A method for operating a computer network comprising the steps:
from a first device of the network, requesting access to a second device of the network;
redirecting the request to a third device of the network;
detecting location information associated with the first device by use of the third device; and
redirecting the request to the second device.

2. The method of claim 1, wherein the access request from the first device is a secure Internet/Intranet connection request.

3. The method of claim 2, wherein the secure Internet/Intranet connection is a TLS (Transport Layer Security)/SSL (Secure Sockets Layer) connection.

4. The method of claim 1, wherein the redirected request is a normal, unsecure Internet/Intranet connection request.

5. The method of claim 1, wherein detecting location information comprises detecting an address of the first device within the network.

6. The method of claim 5, wherein the address is an IP address.

7. The method of claim 6, wherein the address is comprised in an HTTP header.

8. The method of claim 6, wherein detecting location information comprises determining location information associated with the detected IP address.

9. The method of claim 1, wherein the location information is information regarding the country where the first device is located.

10. The method of claim 1, wherein redirecting the request comprises transmitting the detected location information.

11. The method of claim 10, wherein the detected location information is transmitted by performing URL encoding.

12. The method of claim 1, wherein redirecting the request comprises transmitting a key.

13. The method of claim 1, wherein redirecting the request comprises transmitting a time stamp.

14. The method of claim 10, wherein the detected location information is transmitted together with a digital signature.

15. A computer network, comprising:
at least a first, second, and third device, wherein the second device is adapted to redirect an access request of the first device to the third device for detecting location information associated with the first device.

16. The network of claim 15, wherein the access request of the first device is a secure Internet/Intranet connection request, and the redirected request is a normal, un-secure Internet/Intranet connection request.

17. The network of claim 16, wherein the secure Internet/Intranet connection request is a TLS (Transport Layer Security)/SSL (Secure Sockets Layer) connection request.

18. The network of claim 15, wherein the third device detects the location information by detecting the IP address of the first device within the network.

19. The network of claim 18, wherein the third device transmits the detected location information by again redirecting the access request.

20. The network of claim 19, wherein the detected location information is transmitted by use of URL encoding.

21. An apparatus for use in a computer network, adapted to redirect an access request of a first device in the network to a further device in the network for detecting location information associated with the first device.

22. The apparatus of claim 21, wherein the access request of the first device is a secure Internet/Intranet connection request, and the redirected request is a normal, un-secure Internet/Intranet connection request.

23. An apparatus for use in a computer network, adapted to detect location information of a first device in the network by detecting the IP address of the first device, and to transmit the detected location information by redirecting an access request to a further device.

24. The apparatus of claim 23, wherein the detected location information is transmitted by performing URL encoding.

25. A method for operating a computer network comprising:
from a first device of the network, requesting access to a second device of the network;
redirecting the request to a third device of the network;
detecting the address of the first device within the network by use of the third device; and
redirecting the request to the second device.

26. A computer-readable medium having computer-executable instructions for performing a method for operating a computer network comprising:
from a first device of the network, requesting access to a second device of the network;
redirecting the request to a third device of the network;
detecting location information associated with the first device by use of the third device; and
redirecting the request to the second device.
